(19) United States
(12) Patent Application Publication
(10) Pub. No.: US 2023/0098828 A1
(43) Pub. Date: Mar. 30, 2023

(54) MANUFACTURING DEVICE WITH LARGE-AREA SINKING GAS STREAM

(71) Applicant: TRUMPF Laser- und Systemtechnik GmbH, Ditzingen (DE)

(72) Inventors: Florian SCHAEDE, Stuttgart (DE); Robert NEKIC, Remseck am Neckar (DE); Sebastian MATATKO, Pirna (DE)

(21) Appl. No.: 18/060,586

(22) Filed: Dec. 1, 2022

Related U.S. Application Data
(63) Continuation of application No. PCT/EP2021/064630, filed on Jun. 1, 2021.

(30) Foreign Application Priority Data
Jun. 10, 2020 (DE) 102020115414.3

(51) Int. Cl. B22F 12/70; B22F 10/28; B33Y 30/00

(52) U.S. Cl. CPC B22F 12/70; B22F 10/28; B33Y 30/00

(57) ABSTRACT

A manufacturing device for additive manufacture of a three-dimensional component from a powder includes a manufacturing space delimited by a working surface including a powder bed region and a top wall including a protective glass window disposed above the powder bed region. A laser beam can be emitted through the protective glass window and through a beam passage zone to irradiate powder in the powder bed region. A shielding gas system has two outflow ducts, each disposed on the top wall and extending along a duct axis K on each side of the beam passage zone. Each output duct has a duct wall and duct wall sections that allow passage of gas and extend along the duct over an outflow length corresponding at least to an extent of the powder bed region.

### CROSS REFERENCE TO RELATED APPLICATIONS

This application is a continuation of International Application No. PCT/EP2021/064630 (WO 2021/249820 A1), filed on Jun. 1, 2021, and claims benefit to German Patent Application No. DE 10 2020 115 414.3, filed on Jun. 10, 2020. The aforementioned applications are hereby incorporated by reference herein.

### FIELD

The present invention relates to a manufacturing device for the additive manufacture of a three-dimensional component from a powder, wherein the manufacturing device in particular has a shielding gas system.

### BACKGROUND

Laser-based additive manufacture of in particular metal or ceramic workpieces is based on solidifying a starting material present in powdered form by irradiating it with laser light. This concept, also known as selective laser melting, powder bed fusion, or laser metal fusion (LMF), is used inter alia in machines for (metal) 3D printing. An exemplary machine (LMF machine here for short) for producing three-dimensional products is disclosed in EP 2 732 890 A1. The advantages of additive manufacture are generally the simple production of complex and individually creatable parts. In particular defined internal structures and/or structures with an optimized flow of forces can be implemented here.

EP 3 023 228 A1 discloses a manufacturing device for the additive manufacture of a three-dimensional component which supplies a stream of gas over the platform in order to remove, for example, smoke from the interaction zone. Further gas circulation configurations are known, for example from DE 10 2010 052 206 A1, DE 10 2006 014 835 A1, WO 2010/007394 A1, EP 1 839 781 A2, EP 3 147 047 A1, and U.S. Pat. No. 9,592,636 B2.

In additive manufacturing devices, the homogeneity of a gas flow in the manufacturing space is very important for the manufacturing process. Inhomogeneities in the gas flow can result, for example, in different values for the properties of the parts in terms of mechanical properties, density, roughness, discolorations, etc. It moreover needs to be prevented that the laser beam directed at the powder is influenced/weakened by the smoke which is situated in the manufacturing space and is created by the interaction of the laser beam and the powder, and that in this way inhomogeneities and defects in the manufacturing process occur.

As the build space in LMF machines, i.e. that part of the interior which is provided for building components layer by layer, continues to get larger, so the homogeneity and controllability of conventional shielding gas guide systems are reduced. Appropriate more complex concepts for the homogeneous guidance of shielding gas, for example in the region of a volume of 300 mm×300 mm×400 mm for the build space, are thus required.

### SUMMARY

In an embodiment, the present disclosure provides a manufacturing device for additive manufacture of a three-dimensional component from a powder. The manufacturing device includes a working surface and a top wall delimiting a manufacturing space, wherein the working surface includes a powder bed region, the top wall includes a protective glass window disposed above the powder bed region and the manufacturing space includes a beam passage zone disposed between the protective glass window and the powder bed region. A laser beam can be emitted through the protective glass window and the beam passage zone to irradiate powder in the powder bed region. A shielding gas system is also provided having two outflow ducts, each disposed on the top wall and extending along a duct axis K on each side of the beam passage zone. Each output duct has a duct wall defining a duct interior and duct wall sections at an inner side region of each duct wall facing the respective other outflow duct and at an underside region of the duct wall facing the working surface. The duct wall sections allow passage of gas and extend along the duct over an outflow length corresponding at least to an extent of the powder bed region

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic spatial illustration of a view inside a manufacturing space of an exemplary manufacturing device;

FIG. 2 shows a schematic spatial view in vertical section of the manufacturing device indicated in FIG. 1;

FIG. 3 shows a schematic view of a rear wall of the manufacturing device indicated in FIG. 1;

FIG. 4 shows a schematic view of a top wall of the manufacturing device indicated in FIG. 1;

FIG. 5 shows a schematic spatial illustration of exemplary outflow ducts and a feed duct system of a shielding gas system of the manufacturing device;

FIG. 6 shows a schematic horizontal illustration in section of a secondary shielding gas stream being formed close to a top wall of the manufacturing device;

FIG. 7 shows a schematic vertical illustration in section of the secondary shielding gas stream sinking in the manufacturing space of the manufacturing device, and of a primary shielding gas stream flowing over the powder bed;

FIG. 8 shows a schematic spatial exploded illustration of a metal fabric laminate;

FIG. 9A shows a schematic illustration to demonstrate the homogenization of a speed profile with a metal fabric laminate;

FIG. 9B shows a schematic illustration in section of a gas outflow unit for the widening and homogenized outflow of a stream of gas with a metal fabric laminate;

FIG. 10 shows a schematic spatial illustration of exemplary outflow ducts with perforated plates;

FIG. 11 shows a schematic spatial illustration of an exemplary manufacturing device with a gas outflow unit similar to FIG. 9B; and

FIGS. 12A, 12B, and 12C show exemplary embodiments of a duct component for a system for discharging a homogenized output flow.

### DETAILED DESCRIPTION

One aspect of this disclosure is to provide a flow pattern in the manufacturing space which is favorable for the manufacturing process, in particular also for a large build space. It is intended here that the flow pattern furthermore shields optical components and prevents or at least reduces the influencing of the laser beam by, for example, smoke.

A further aspect of this disclosure is to homogenize a flow and/or to effect even distribution of a flow over an outflow region which covers a large area compared with an inflow opening.

A manufacturing device is provided for the additive manufacture of a three-dimensional component from a powder.

In a first aspect, a manufacturing device for the additive manufacture of a three-dimensional component from a powder with a working surface and a top wall is disclosed, wherein the working surface and a top wall delimit a manufacturing space and the working surface comprises a powder bed region. The top wall comprises a protective glass window arranged above the powder bed region. A beam passage zone of the manufacturing space, into which a laser beam can be emitted through the protective glass window to irradiate powder in the powder bed region, extends between the protective glass window and the powder bed region. The manufacturing device moreover comprises a shielding gas system. The shielding gas system comprises two outflow ducts, which each comprise a duct wall for defining a duct interior, arranged on the top wall on both sides of the beam passage zone. Each of the outflow ducts comprises duct wall sections, which allow the passage of gas, in an inner side region of the duct wall facing the respective other outflow duct and in an underside region of the duct wall facing the working surface. The duct wall sections which allow the passage of gas are provided along a duct axis of the outflow duct over an outflow length which corresponds at least to the extent of the powder bed region in the direction of the duct axis.

In some embodiments of the manufacturing device, a shielding substream directed along the top wall is associated with the inner side region. The shielding substream flows in particular partially along the protective glass window. A sinking substream directed perpendicularly at the working surface is associated with the underside region.

In some embodiments of the manufacturing device, in at least one of the outflow ducts, the inner side region can transition into the underside region in a transition region with one or more beveled outer surfaces, wherein at least one of the one or more beveled outer surfaces is in particular a rectangular planar surface.

In some embodiments of the outflow ducts, in at least one of the outflow ducts the inner side region can transition into the underside region in a transition region with a rounded outer surface, in particular gradually, wherein the rounded outer surface has in particular a radius of curvature within the range from, for example, 10 mm to 200 mm or has a varying radius of curvature.

In some developments, at least one shielding/sinking substream, which is directed into the beam passage zone and enters the beam passage zone in particular at an angle within the range from 10° to 80° relative to the top wall, is associated with the transition region.

In some embodiments of the outflow ducts, at least one of the duct wall sections which allow the passage of gas is formed as a fabric layer or fabric laminate with at least two fabric layers, in particular as a metal fabric laminate. In a duct wall section which allows the passage of gas, the fabric layer or the fabric laminate can comprise fabric meshes which are provided as outflow openings for the flow-homogenizing passage of gas from the duct interior into the manufacturing space. In particular, superposed fabric layers can have different mesh widths.

In some embodiments, at least one of the duct wall sections which allow the passage of gas can
extend over at least 80% or 90% of a duct length and/or
comprise a nonwoven laminate or a perforated plate with an arrangement of outflow openings.

In some embodiments, at least one of the outflow ducts can comprise at least one baffle which extends from the inner side region in the direction of the center of the duct interior and by means of which gas flowing along the outflow duct can be deflected toward a duct wall section, which allows the passage of gas, of the inner side region and optionally of the intermediate region. The at least one baffle can in particular be curved and/or be provided with openings at least partially, in particular close to the center of the duct interior. Alternatively or additionally, at least one of the outflow ducts can comprise at least one fabric layer, fabric laminate, metal fabric laminate, or nonwoven laminate, arranged transversely to the duct axis.

In some embodiments, the shielding gas system can moreover comprise a redirection box with a feed duct and two transition duct sections fluidically connected to the feed duct, wherein
each of the transition duct sections is fluidically connected to one of the outflow ducts at the outlet side, and
at least one of the transition duct sections for fanning out a stream of gas is adapted to a cross-section of the fluidically connected outflow duct, wherein in particular a feed duct width which is present perpendicular to a transition duct axis is at least 80% of an outflow duct width which is present perpendicular to a duct axis of the outflow duct.

In some developments of the feed duct system, one of the transition duct sections can be fluidically connected to one of the outflow ducts at an angle between a transition duct axis and a duct direction of the outflow duct within a range from 80° to 100°. Alternatively or additionally, the transition duct sections and the outflow ducts can be formed in the connecting region in each case with a flattened cross-section with a width-to-depth ratio of at least 2:1.

In some developments of the feed duct system, at least one of the transition duct sections can be integrated into a rear wall of the manufacturing device which extends between the working surface and the top wall and delimits the manufacturing space, or extend along said rear wall.

In some embodiments, the shielding gas system can moreover comprise a surface stream duct system for supplying a surface stream which flows over the working surface. In some embodiments, the surface stream duct system can have a surface stream discharge section and a suction section. The surface stream discharge section can be designed
to guide gas to at least one outlet opening which extends in a strip along the working surface, and
to effect a uniform flow of the gas into the manufacturing space, and the suction section is designed
to draw gas from the manufacturing space through an intake opening, wherein the intake opening extends in a strip along the working surface, and
to effect a uniform intake of gas from the manufacturing space.

In some developments of the surface stream duct system, the surface stream discharge section can have a flat feed duct with which a direction of flow is associated which runs at an angle within the range from 70° to 110°, in particular 80° to 100°, to the direction of flow of the surface stream emerging from the outlet opening.

In some developments of the surface stream duct system, the suction section can comprise a profile part which delimits the intake opening on the side of the top wall or the side of the working surface and has a nose-shaped, in particular parabolic cross-section.

In some developments of the manufacturing device, the shielding gas system can form a flow pattern which comprises as a primary flow component:
the surface stream which flows over the working surface with a height of at least 5 mm up to, for example, 30 mm and more, for example 100 mm and more, for example approximately 60 mm, and as a secondary flow component:
the shielding substreams which flow from both outflow ducts along the top wall, meet each other, and then flow onward together in the direction of the working surface,
the sinking substreams which flow from the underside regions to the working surface, and
optionally further shielding/sinking substreams which flow from the transition regions obliquely into the beam passage zone and then flow onward in the direction of the working surface,
   as a result of which a sinking flow is formed in the beam passage zone toward the working surface which is drawn, together with the surface stream, through the suction opening out of the manufacturing space.

The concepts described herein relate in particular to manufacturing devices in which, by means of the positioning and expansion of the duct wall sections which allow the passage of gas, the formation of a homogeneous shielding gas flow in the manufacturing space is enabled which is characterized by a large-area sinking substream and a shielding substream. In this way, it can be prevented that the manufacturing process or the manufacturing quality is affected by rising smoke. This is because, on the one hand, smoke can be prevented by the large-area sinking substream from rising in the manufacturing space and influencing the laser beam. On the other hand, the smoke can be prevented by the shielding substream from being deposited on a protective glass window.

Because the shielding gas can flow into the manufacturing space through the duct wall sections which allow the passage of gas over the whole outflow length (which corresponds at least to the extent of the powder bed in the direction of the duct), a particularly uniform, homogeneous flow pattern is enabled in the region of the powder bed, which is beneficial for the quality of the manufacturing process. The formation of a homogeneous flow pattern in the manufacturing space is also beneficial if the transition region in which the inner side region transitions into the underside region is characterized either by one or more beveled outer surfaces or a rounded outer surface.

The outflow from an outflow duct takes place in particular in a directed fashion and with a homogeneous speed distribution over the whole surface. It is thus intended that as far as possible no flow hot spots, turbulence, or recirculation are generated.

This can in particular be achieved by at least one of the gas-permeable duct wall sections being formed with a fabric. A gas-permeable duct wall section can be configured, for example, as a fabric layer or a fabric laminate comprising at least two fabric layers.

A fabric has a flat design such that a fabric surface can extend usually transversely to the gas stream and completely cover the latter. A fabric can have an arrangement consisting of a material with a thread-like design, for example a metal wire with a round or polygonal cross-section. The fabric forms a plurality of neighboring meshes, wherein the material sections belonging to a mesh delimit a (through) opening. The spacing between two material sections which delimit an opening on opposite sides is referred to as the mesh width.

The arrangement consisting of a material with a thread-like design can, for example, be constructed from intersecting metal wire sections which, in a plan view of the fabric surface, intersect in a pattern at an angle of, for example, approximately 90° (right-angled fabric mesh) or 60°/120°. It will be known to a person skilled in the art that a wide range of angles of intersection can be used in the present application.

The mesh width and the number of fabric layers can be selected with regard to the respective effect on the flow. By adapting the mesh widths and placing a plurality of fabric layers in a row in a fabric laminate, a defined pressure difference between the two sides can be set for a fluid in, for example, a gas circuit of an additive device such that a desired permeability of the fabric laminate for the fluid can be achieved. The permeability can also be referred to as a resistance coefficient. The higher this resistance coefficient, the more homogeneously the speed distribution can be formed. The arrangement of the fabric laminate can thus also permit a user-defined speed distribution, for example different outlet speeds for different surface segments.

Alternatively, the gas-permeable duct wall sections can be designed, for example, as perforated plates or consist of a nonwoven or a multi-layer nonwoven laminate or comprise them at least in some places.

By virtue of the configuration of an (in particular curved) baffle attached additionally in the outflow duct, it is possible to influence the relative volume flow ratio of the shielding substream, the sinking substream, and optionally the shielding/sinking substream. Openings which the baffle can have (perforations) can contribute to the flow not becoming separated from a baffle, with the formation of turbulence, during the redirection by the baffle on the suction side of the baffle; in the same way as a fabric layer arranged transversely to the direction of the duct, a fabric laminate, a metal fabric laminate, or a nonwoven laminate, this benefits the homogenization of the flow flowing into the manufacturing space.

The shielding gas system disclosed herein can form an extensive sinking stream and an efficient optical barrier stream as a secondary flow, the flow pattern of which can effectively prevent smoke particles from rising up under convection. The uniform secondary flow can moreover wash over the process zone (the manufacturing space) more efficiently. Even in the case of long build jobs, a “cleaner” process atmosphere and “clean” optical components can thus ensure a more robust manufacturing process because of a lower particle concentration. Moreover, a flow concept can be implemented which has a low degree of complexity by virtue of the primary and secondary flows. The manufacturing process can moreover be more robust in terms of a variable splitting of the volume streams; in particular, fluctuations in a flow setting within a setting range can be noncritical.

Concepts which allow aspects from the prior art to be at least partially improved are disclosed herein. In particular, further features and their expediencies will become apparent from the following description of embodiments with reference to the drawings.

The concepts disclosed herein are based at least partially on the insight of the inventors that recirculating a shielding gas flow in the region between a process plane (formed in particular here by the substrate plate with the powder bed) and a laser coupling disk can lengthen the dwell time of process by-products. Because the process by-products absorb laser power, when there is recirculation, a modified, undesired and in some circumstances also random LMF process can occur.

In order to counteract such effects, inter alia, the inventors propose a large-area, directed (secondary) shielding gas stream. This is provided in particular to obtain a continuous flushing effect of the process region in the manufacturing space or even of the whole manufacturing chamber.

In a secondary shielding gas flow pattern, formed according to the invention, in an LMF machine, shielding gas can flow out of a shielding gas module which is fastened to a cover of the LMF machine. The shielding gas module can generate in particular a secondary shielding gas stream which runs substantially mirror-symmetrically relative to a coupling pane of the LMF machine (also referred to herein as the protective glass window).

Substreams of the secondary shielding gas stream flow from both sides in the direction of the coupling pane and in parallel along the latter. These substreams meet in the center and flow downward in the direction of the substrate plate. Further substreams of the secondary shielding gas stream flow, for example, from a double bevel, in each case with a planar design, of the shielding gas module (or alternatively from a bevel which is curved with a radius) slightly obliquely downward in the direction of the substrate plate. Further substreams of the secondary shielding gas stream flow straight down from the bottom of the shielding gas module which extends parallel to the substrate plate. The different substreams interact in order to obtain a flow which is as laminar as possible and is directed from above at the substrate plate and thus prevent/reduce turbulence.

With regard to the extent of the secondary shielding gas flow pattern, it can be sufficient if the substrate plate is covered by the down-flowing substreams. In this respect, it is not necessary that the shielding gas module extends as far as the front wall and/or as far as the rear wall of the manufacturing device.

To summarize, the secondary stream is designed as an extensive sinking stream which implements constant flushing of the process zone with “clean gas”, i.e. the shielding gas.

The secondary shielding gas stream is combined with a primary shielding gas stream. The primary shielding gas stream (primary stream for short) is designed to carry along smoke which occurs in the direct process zone, i.e. directly above the powder bed, in the direction of a suction opening. By removing the smoke, the primary stream can prevent or at least reduce unnecessary interactions between metal vapor, smoke particles, and the laser beam in the direct process zone. For a position-independent and robust LMF process, a uniform, virtually stationary, primary shielding gas flow pattern with a homogeneous speed profile over the length and width of the build platform (substrate plate) is employed.

As will be explained below in connection with the drawings, the proposed secondary shielding gas flow pattern can prevent or at least reduce an unreliable particle load and particle concentration inside the process chamber. By virtue of the directed and extensive flushing process, the secondary stream contributes to it being possible to reduce the particle concentration in the whole process zone. This can positively influence defocusing and pointing stability of a processing laser beam, critical for the process, and result in a stable process window over the whole build platform.

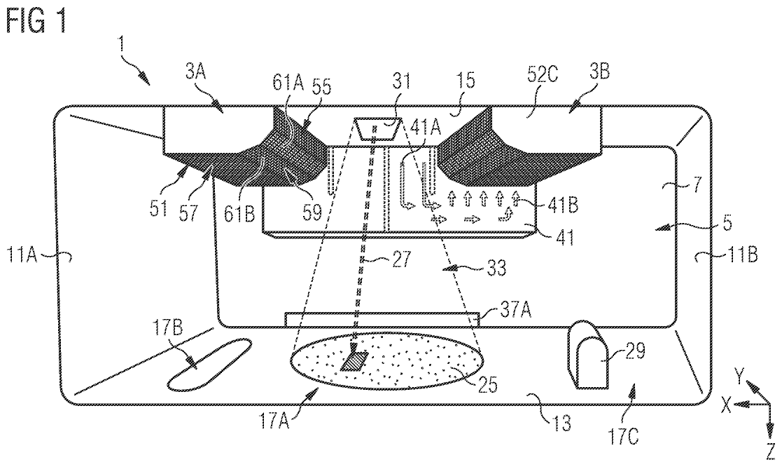

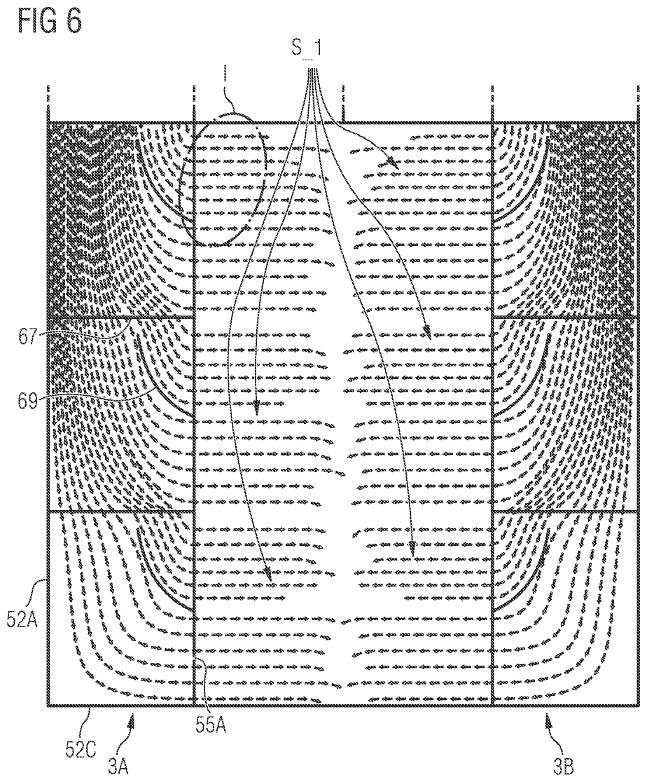

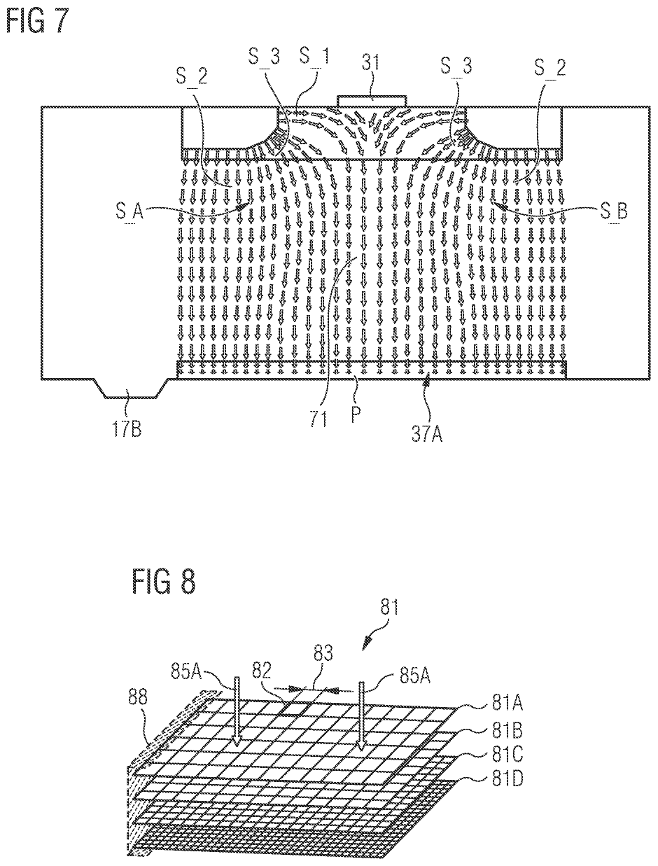

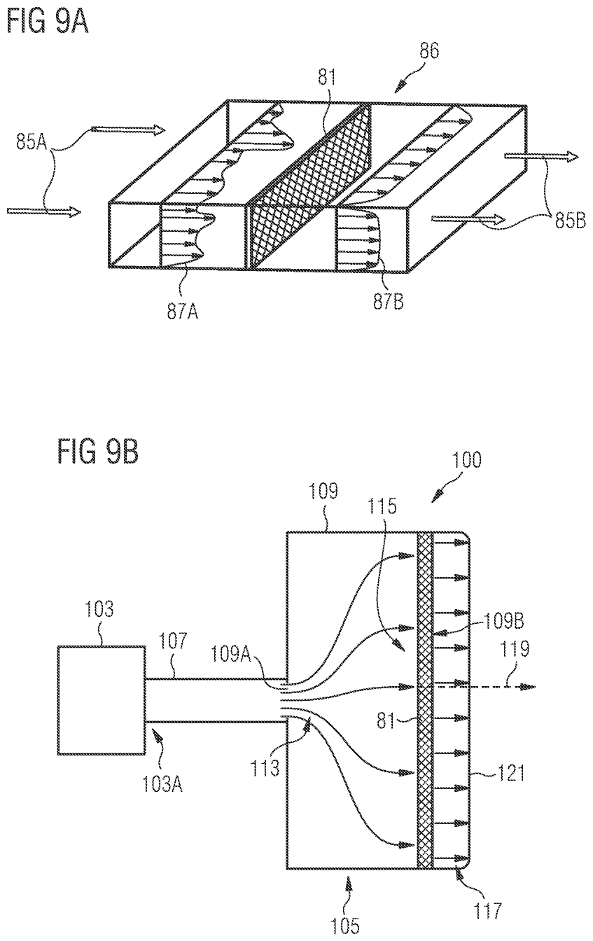

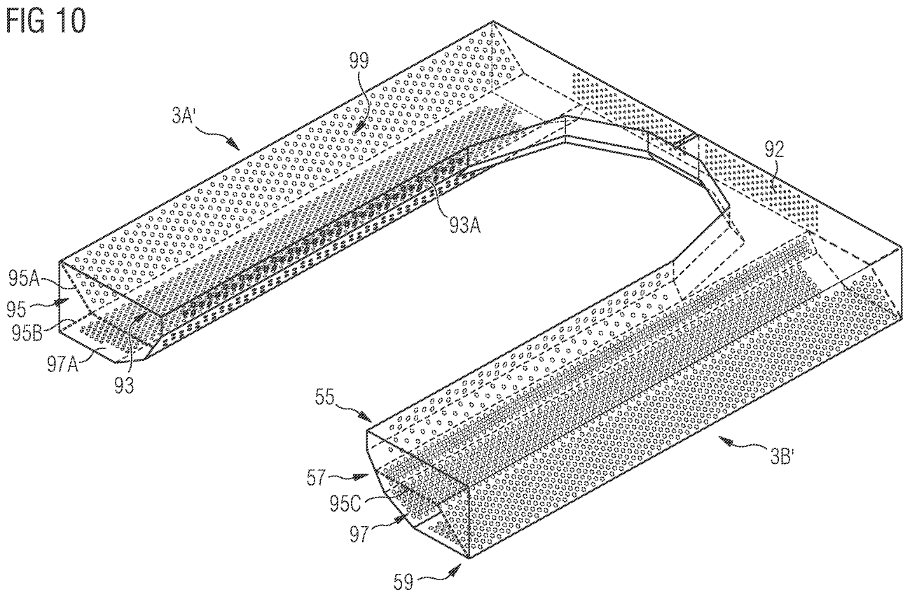

An exemplary structure of a manufacturing device for the additive manufacture of a three-dimensional component from a powder will be described with reference to FIGS. 1 to 5, wherein a secondary shielding gas flow pattern is generated in the manufacturing device in the form of an extensive sinking stream with a shielding gas module, in particular with two outflow ducts. The pattern of the shielding gas flow in the manufacturing device will be explained with the aid of FIGS. 6 and 7. Homogenization of a flow with a metal fabric laminate in general and specifically of a flow, for example, in the outflow ducts will be explained in connection with FIGS. 8 and 9. An alternative embodiment of a shielding gas module will be described in FIG. 10.

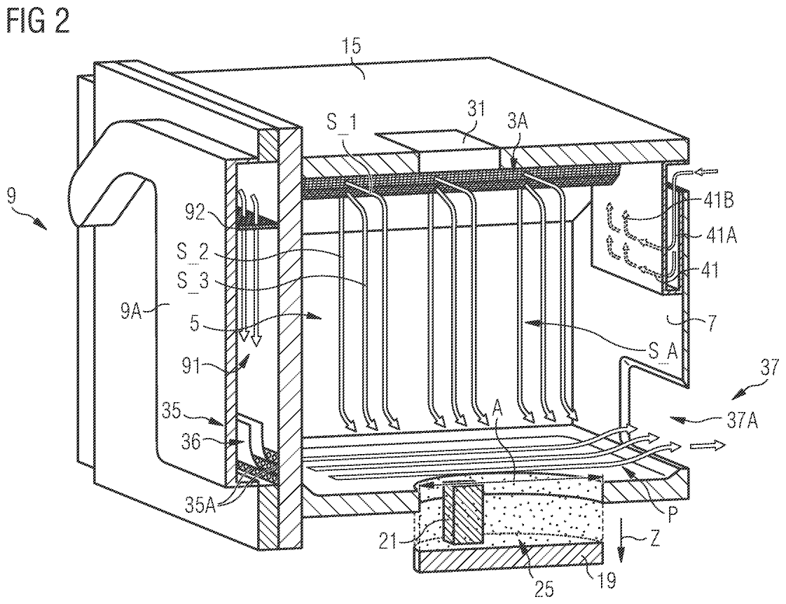

An exemplary embodiment of a manufacturing device 1 with a shielding gas module which comprises two outflow ducts 3A and 3B is shown in FIGS. 1 to 5. The manufacturing device 1 provides a manufacturing space 5 for additive manufacture. The manufacturing space 5 is delimited by a rear wall 7, a front wall 9 (comprising a door 9A in FIGS. 2 and 4), and two side walls 11A and 11B in the X and Y directions. The manufacturing space 5 is delimited at the bottom and the top (i.e. in the Z direction) by a working surface 13 and a top wall 15.

The working surface 13 comprises a, for example, circular powder bed region 17A above a substrate plate 19 on which a component 21 is generated from powder 25 by melting the powder 25 with a laser beam 27.

The working surface 13 moreover comprises a powder removal region 17B and a powder supply region 17C. The powder 25 can be conveyed from the powder supply region 17C into the powder bed region 17A and excess powder 25 onward into the powder removal region 17B by means of a spreader 29.

The top wall 15 comprises a protective glass window 31 which is arranged above the powder bed region 17A and through which the laser beam 27 is coupled into the manufacturing space 5. The laser beam 27 there passes through a beam passage zone 33 which extends between the protective glass window 31 and the powder bed region 17A. The beam passage zone 33 is the region into which the laser beam 27 can be deflected in order to melt the powder 25 on the surface of the powder bed.

The manufacturing device 1 moreover has a shielding gas system with which the gas conditions in the manufacturing space 5 during the manufacture of the component 21 can be set.

The shielding gas system is designed to generate a primary shielding gas stream P which flows over the powder bed region 17A, in particular over the powder bed. To do this, the shielding gas system comprises a shielding gas duct system which ends in the door 9A in a surface stream discharge section 35 indicated in FIG. 2. Shielding gas for the flat primary shielding gas stream P is discharged from openings 35A of the surface stream discharge section 35 into the manufacturing space 5 close to the working surface 13.

The primary shielding gas stream P extends as far as an intake opening 37A of a schematically indicated suction section 37 of the shielding gas system. In the example shown, the intake opening 37A is formed on the rear wall 7 close to the working surface 13 and in a strip along the working surface 13. The suction section 37 is fluidically connected to a suction pump (not shown).

The shielding gas system is moreover designed to generate a secondary shielding gas stream S. The secondary shielding gas stream S flows from above down onto the powder bed region 17A, in particular onto the powder bed. For this purpose, the shielding gas system comprises the outflow ducts 3A, 3B arranged on the top wall 15 on both sides of the beam passage zone 33. The shielding gas system moreover comprises a redirection box 41 which extends at the rear wall 7 of the manufacturing apparatus 1, connected to the top wall 15, and supplies the outflow ducts 3A, 3B with shielding gas at a slightly elevated pressure (pressure difference from the manufacturing space of, for example, a few millibars, for example within the range from 1 to 3 mbar). Thus, a pressure loss of approximately 500 pascals (5 millibars) between upstream and downstream of an appropriately configured metal fabric laminate can result, for example, for an outlet speed of approximately 0.2 m/s, wherein a higher pressure loss can result in a higher degree of homogeneity of the speed.

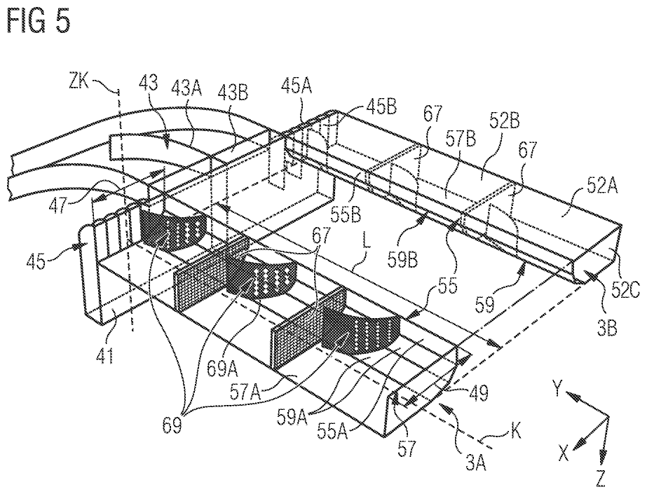

FIG. 5 shows the outflow ducts 3A, 3B as well as the redirection box 41 in a semitransparent illustration. The outflow ducts 3A, 3B extend along a duct axis K in the X-Y plane, wherein the duct axis K runs in the Y direction.

The shielding gas is fed to the redirection box 41 from behind through the rear wall 7 via a feed duct 43. The shielding gas is split into two arms, each of which is associated with one of the outflow ducts 3A, 3B. In the case of a symmetrical structure of the outflow ducts 3A, 3B, the redirection box 41 can also be designed symmetrically with two redirection box sections for the two arms. A uniform splitting of the feed of the shielding gas into the redirection box sections can be effected, for example, via a fin 43A (or a plurality of fins) arranged centrally (for example, in the plane of section of FIG. 2) and/or with one or more perforated plates 43B (perforated plate bulkheads).

In each of the redirection box sections, the shielding gas is first deflected downward and then, after being redirected by 180° (flow arrows 41A in the Z direction, flow arrows 41B in the “−Z” direction, see FIGS. 1 and 2), upward along a transition duct axis ZK to the outflow ducts 3A, 3B. The shielding gas flowing upward in the “−Z” direction accordingly flows orthogonally to the duct axes K of the outflow ducts 3A, 3B, wherein the transition duct axis ZK can also run at an angle of less than 90°, for example within a range from 70° to 90°, relative to the duct axis K.

Each of the redirection box sections forms on the outlet side a transition duct section 45 which is fluidically connected to one of the outflow ducts 3A, 3B via an opening. The transition duct section 45 can have a rounded (as indicated by way of example in FIG. 5) or square design. Further redirection of the shielding gas takes place here from a flow along the transition duct axis ZK of the transition duct section 45 into a flow along the duct axis K. The transition duct axis ZK and the duct axis K run at an angle of in the region of 90°. Uniform deflection of the flow is achieved, for example, by rounded walls 45A and flow vanes 45B oriented along the transition duct axis ZK.

The transition duct sections 45 and the openings are matched to a cross-sectional surface of the outflow ducts 3A, 3B in the X-Z plane. A feed duct width 47, situated in the X-Z plane and specified in the X direction, of the opening of the transition duct section 45 is, for example, at least 80% of an outflow duct width 49 that is perpendicular to a duct direction K of the outflow duct 3A, 3B.

Very compact feeding of the shielding gas into the laterally offset outflow ducts 3A, 3B can be effected by the redirection box 41 arranged in the Z direction along the rear wall 7. In addition, the redirection offers the advantage that shielding gas can be conducted to the outflow ducts 3A, 3B perpendicularly to the X-Y plane. As a result, in contrast to redirection in the X-Y plane, the swirling and inertia of the shielding gas (in the X-Y plane) can be reduced already when it flows into the outflow ducts 3A, 3B. Outflow of the shielding gas, with no recirculation, from the outflow ducts 3A, 3B into the manufacturing space 5 is thus provided as early as the beginning of the outflow ducts 3A, 3B (see region I of the flow pattern in FIG. 6).

The outflow ducts 3A, 3B are designed in such a way that the outflow of the shielding gas preferably takes place over the whole length L of the outflow ducts 3A, 3B into the manufacturing chamber 5 and preferably into the beam passage zone 33. For this purpose, a change in the direction of flow along the duct axis K (in FIGS. 1 to 5, the main direction of flow runs into the outflow ducts 3A, 3B in the “−Y” direction) both downward, as a sinking stream, and “inward”, as a barrier stream for the optical system/the protective glass window 31 is required.

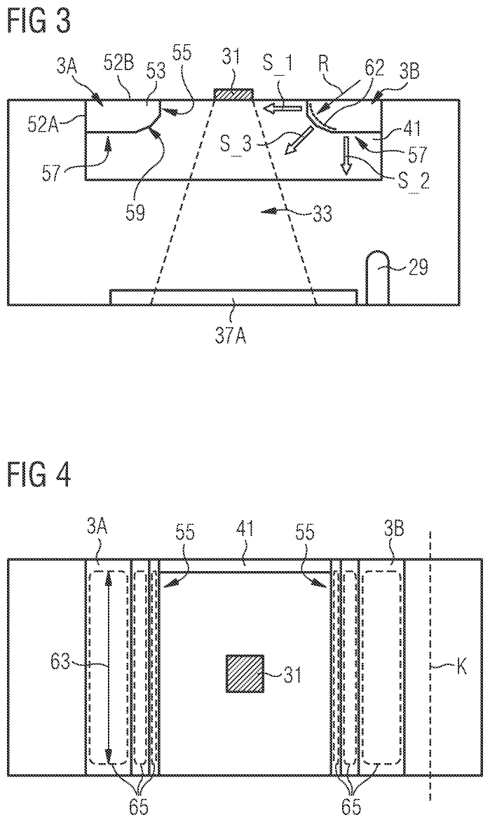

Each of the two outflow ducts 3A, 3B has a duct wall 51 for delimiting a duct interior 53. The duct wall 51 has a gas-tight design at the top and on the outside, i.e. on the sides not directed at the beam passage zone 33, labeled in particular in FIGS. 3 and 5 as the duct outer wall 52A, the duct top wall 52B, and the duct front wall 52C. On the sides directed at the beam passage zone 33, large-area duct wall sections which allow the passage of shielding gas are provided in the duct wall 51 for the purpose of discharging shielding gas.

For example, inner side regions 55, facing the respective other outflow duct 3A, 3B, of the duct wall 51 have duct wall sections 55A, 55B which allow the passage of gas. Underside regions 57 facing the working surface 13 have duct wall sections 57A, 57B, which allow the passage of gas, in the duct wall 51.

In the cross-sectional shape shown by way of example in FIG. 5, the inner side region 55 transitions into the underside region 57 in a transition region 59 with in each case two beveled outer surfaces 61A, 61B (forming rectangular planar surfaces). Duct wall sections 59A, 59B which allow the passage of gas are also provided in the transition region 59.

A curved profile of the duct wall in the inner side region 55 and in the transition region 59 is shown in addition in FIG. 3. The rounded outer surface 62 which can transition in particular gradually into the underside region 57 can be seen. The rounded outer surface can in particular have a radius of curvature R within the range from 10 mm to 200 mm or a radius of curvature which varies within this range.

The duct wall sections 55A, 55B, 57A, 57B, 59A, 59B which allow the passage of gas each have an outflow length extending in the duct direction K. The duct wall sections 55A, 55B, 57A, 57B, 59A, 59B which allow the passage of gas preferably extend as far as possible through the whole manufacturing space 5 (from the back to the front in the Y direction). The outflow length is generally greater than an extent A of the powder bed along the duct axis K. An outflow length 63 for duct wall sections which are illustrated schematically in FIG. 4 by regions 65 bordered by dashed lines is indicated in FIG. 4. In FIG. 5, the whole duct wall has, for example, a gas-permeable design in the inner side region 55, the underside region 57, and the transition region 59, as can also be seen from the associated flow patterns in FIGS. 6 and 7. In order to be able to extend over the whole length L of the outflow ducts 3A, 3B, the duct wall sections which allow the passage of gas can be formed, for example, as a multi-layer metal fabric laminate, as will be explained in connection with FIGS. 8 and 9. A fabric laminate generates a greater pressure difference than conventional perforated plates and can furthermore provide an outflow surface covering the whole cross-sectional area of the duct wall sections.

In the perspective view in section in FIG. 2, a composition of the secondary gas stream S in the manufacturing space 5 consisting of a plurality of substreams S_1, S_2, S_3 is indicated, as they flow out, for a secondary substream S_A, from the outflow duct 3A, specifically from the duct wall sections which allow the passage of gas:

The substream S_1 flows as a “shielding substream” from the inner side region 55 of the outflow duct 3A along the top wall 15 and meets the substream of the outflow duct 3B, flowing in the opposite direction, approximately centrally between the outflow ducts 3A, 3B. As a result, the substreams S_1 are deflected and flow downward in the central region of the beam passage zone 33 as sinking streams in the direction of the working surface 13. See also the flow lines of the substream S_1 in the shielding gas flow pattern in FIG. 6.

The substream S_2 flows as a “sinking substream” from the underside region 49 to the working surface 13. The substream S_3 flows as a “shielding/sinking substream” from the transition region 27 obliquely into the beam passage zone 33 and is then carried along in the direction of the working surface 13 by the substreams S_1. See also the flow lines of the substreams S_2 and S_3 in the shielding gas flow pattern in FIG. 7.

The substreams S_1, S_2, S_3 of the outflow ducts 3A, 3B together form a large-area sinking flow in the beam passage zone 33 onto the working surface 13 (see FIG. 7).

An even distribution of the secondary substreams S_A, S_B on both sides over the whole duct length and the outflow surfaces of the outflow ducts 3A, 3B (i.e. the duct wall sections 55A, 55B, 57A, 57B, 59A, 59B which allow the passage of gas) can be assisted by a multi-layer fabric laminate 67 (see also FIG. 9b). The fabric laminate 67 extends in the duct interior 53 so that it covers the whole cross-sectional area transversely to the duct direction K.

So that the outflow can also be effected into the central region between the outflow ducts 3A, 3B and in order thus to ensure an efficient “optical system” barrier stream, in particular perforated baffles 69 can be provided in the outflow ducts 3A, 3B at regular intervals. They deflect some of the shielding gas in the duct interior 53. Perforation of the, for example, profiled baffles can prevent separation on the suction side of the baffles and thus effect a stable flow around the baffles with no significant dead-water/separation areas.

In the example shown in FIG. 5, each outflow duct 3A, 3B has, for example, at least one curved baffle 69 with openings 69A. The baffles 69 extend from the inner side region 55 in the direction of the center of the duct interior 53. They deflect gas which flows along the outflow duct 3A, 3B to the duct wall sections 55A, 55B, 57A, 57B, which allow the passage of gas, of the inner side region 55 and the transition region 57.

FIGS. 6 and 7 illustrate a flow pattern in the manufacturing space 5 as can be achieved using the concepts proposed herein.

FIG. 6 shows, in a schematic illustration in section in the X-Y plane close to the top wall 15, the pattern of the secondary shielding gas flow S. The shielding substreams S_1 which flow from the two outflow ducts 3A, 3B through the gas-permeable duct walls into the manufacturing space 5 and flow along the top wall 15 meet each other centrally and then flow together in the direction of the working surface 13 (here into the plane of the drawing). A homogeneous, uniform flow pattern is thus formed in the whole region between the two outflow ducts 3A, 3B. Turbulence and recirculation can be reduced. Reference is made in particular to the virtually turbulence-free flow lines in the region I right at the beginning. The reduced turbulence stems, inter alia, from the angled feed (90° angle between the duct axis K and the transition duct axis ZK) with comparable duct widths in the X-Y plane.

FIG. 7 shows, in a schematic illustration in section in the X-Y plane, the secondary shielding gas flow S sinking in the manufacturing space 5 as well as the primary shielding gas flow P flowing over the powder bed. Also visible here is the manner in which the shielding substreams S_1 first flow from the inner side regions 55 along the top wall 15, meet each other, and then flow onward together in the direction of the working surface 13. It can moreover be seen that the sinking substreams S_2 flow from the underside regions 57 to the working surface 13 and that the shielding/sinking substreams S_3 flow out of the transition regions 59 obliquely into the beam passage zone 33 and then flow onward in the direction of the working surface 13.

As a result, a large-area sinking flow 71 in the beam passage zone 33 onto the working surface 13 is formed. The sinking flow 71 flows partially into the primary shielding gas stream P and is then drawn with the latter through the intake opening 37A and out of the manufacturing space 5.

As already claimed, an even distribution and a homogenization of a compact flow over fabric laminates can be achieved.

FIG. 8 shows a schematic spatial exploded illustration of a fabric laminate 81 as can be used, for example, as a duct wall which allows the passage of gas in one of the duct wall sections 55A, 55B, 57A, 57B, 59A, 59B. The fabric laminate 81 here comprises a plurality of fabric layers 81A, 81B, 81C, 81D, four of the latter being shown by way of example. The fabric layers 81A, 81B, 81C, 81D are made, for example, from metal such as, for example, all common stainless steels (for example, 1.4401 or 1.4404), chromium-nickel-molybdenum steels, or nickel-based alloys, for example Hastelloy alloy or Inconel alloy, and can accordingly be exposed to the temperatures in the manufacturing space 5 that exist during the additive manufacture. Each fabric layer 81A, 81B, 81C, 81D of the fabric laminate 81 has fabric meshes 82 which are provided as through openings for the flow-homogenizing passage of a fluid flowing through the fabric laminate 81 (fluid stream 85A). The fabric meshes 82 are arranged uniformly next to one another, in this case, for example, adjoining one another in rows and columns in the respective fabric layer 81A, 81B, 81C, 81D. By way of example, as indicated in FIG. 8, fabric meshes 82 arranged in an individual fabric layer 81A, 81B, 81C, 81D can have a standard mesh width 83 in at least one direction. Exemplary dimensions of the mesh width 83 lie within the range from 10 μm to 2 mm. The mesh widths 83 of successive fabric layers 81A, 81B, 81C, 81D can decrease in the direction of flow. In some embodiments, the mesh width 83 can moreover decrease or increase in the direction of flow in some places. Thus, for example, an outer protective layer can be provided with a mesh width which is greater than the mesh width of the penultimate fabric layer. Fabric meshes 82 preferably have a standard geometry, for example rectangular, square, diamond-shaped, round, or elliptical, and form, for example, correspondingly shaped through openings.

A surrounding frame structure 88, by means of which the plurality of fabric layers 81A, 81B, 81C, 81D can optionally be held together and fastened to the housing, is moreover indicated schematically in dashed lines in FIG. 8 for the fabric laminate 81.

As can be illustrated in FIG. 9A with the example of a duct component 86, the fluid stream 85A which flows through the fabric laminate 81 and, as shown in FIG. 9A, has an irregular initial speed profile 87A can be homogenized with the aid of the fabric laminate 81. The effected equalization of an emerging fluid stream 85B is indicated schematically in FIG. 9A. The fluid stream 85B has a speed profile 87B which extends over the whole cross-section of the duct component 86 essentially with the same speed. With regard to the attachment of the duct component 86 to a low-pressure compressor, reference is made to FIG. 9B, wherein a person skilled in the art is able to transfer the description of the geometrical conditions in FIG. 9B (inlet opening, outlet opening, the latter spaced apart in the duct component 86 from the fabric laminate 81, etc.) correspondingly to the connection of the duct component 86 to the low-pressure compressor via a fluid line.

A plurality of metal fabric layers can be connected to one another via a sintering process or the like. Because of the material (for example, metal), these fabric layers can be temperature-resistant and robust with respect to a large number of media and are suited in particular also for high-temperature applications in 3D printing (LMF machines). By means of the defined and uniform mesh width 83 of the fabric and the interconnection (succession) of a plurality of fabric layers, in particular metal fabrics can be used as flow homogenizers of gaseous flows in LMF machines. If a fluid flows through the fabric laminate, a pressure drop occurs between the inlet and outlet surface, resulting from the flow resistance built up by the fabric laminate. A defined flow rate can be set over the whole surface of the fabric laminate by means of the flow resistance which can be specified by the mesh widths employed.

If in particular low flow speeds (less than 1 m/s) are desired when the fluid stream 85B emerges, gas circulation with a low-pressure compressor (for example, an axial ventilator or side duct compressor) can be performed, for example, in a gas circulation system of an LMF machine. The exchange of gas can here be effected by small pressure differences in the region of some 10 mbar, for example within the range from 1 to 5 mbar, on either side of the fabric laminate (a maximum of 200 mbar to 300 mbar), i.e. there is only a slightly elevated pressure in the duct component relative to the manufacturing space 5, over the long duration of the 3D printing process with low power consumption of the low-pressure compressor. The low-pressure compressor can in general be formed for generating a continuous stream of gas.

To illustrate the function of a fabric layer or a fabric laminate for a uniform inflow of a gas into a space (for example, into the manufacturing space 5 of an LMF machine), FIG. 9B shows a schematic side view in section of a system 100 for discharging a homogenized flow. The system comprises a low-pressure compressor 103 and a duct component 105 which is connected to the low-pressure compressor 103 via a fluid line 107. The low-pressure compressor 103 is configured to supply gas fed in at an input pressure to a compressor output 103A at an output pressure, wherein the output pressure is greater than the input pressure by in the region of some 10 mbar.

The duct component 105 comprises a duct housing 109 with an inlet opening 109A which is fluidically connected to the compressor output 103A via the fluid line 107 (for example, a tube). The duct housing 109 moreover comprises an outlet opening 109B for forming a duct between the inlet opening 109A and the outlet opening 109B. In other words, the duct component 105 serves as a plenum in which a gas stream 113 emerging from the fluid line 107 toward an outflow region 115 with a flat design is widened out. The outflow region 115 can be formed by a planar fabric laminate (with a flat design and extending within a plane). The fabric laminate can comprise a plurality of fabric layers which allow the passage of gas (see, for example, FIG. 9A and the associated description).

Each of the fabric layers consists of a plurality of fabric meshes which form through openings which together effect the flow-homogenizing passage of the gas through the fabric laminate in order to form a homogeneous output flow 117. As in FIG. 9A, the fabric meshes can be arranged uniformly in rows and/or columns in the respective fabric layer and fabric meshes arranged in an individual fabric layer can have a common mesh width, wherein the mesh width can, for example, become finer from layer to layer, at least for some fabric layers. As indicated in FIG. 9B, when it leaves or after it has left the outflow region 115, the gas of the output flow 117 flows in the direction of a surface normal 119 of the planar outflow region 115.

The flow-homogenizing effect of the fabric laminate which allows the passage of gas enables widening-out within a compact plenum and uniform distribution of the gas stream in the plenum over a surface of the outflow region 115 which is relatively large compared with the inlet opening 109A. The homogenization can occur even in the case of a very compact structure of the widening region 115, wherein higher pressures/denser fabrics may then be necessary and deflection plates can be additionally provided. The flow-homogenizing approach disclosed herein in general makes it possible that only a small thickness of the plenum (for example, in the region of a few (for example, some ten) millimeters in the case of, for example, fabric laminate thicknesses in the region of approximately 5 mm provided that the fabric laminate generates a sufficiently high pressure loss) is required in the direction of the surface normal 119 of the planar outflow region 115.

The uniform distribution of the emerging gas in the output flow 117 over the surface of the outflow region 115 is shown, for example, in the homogeneity of a speed profile 121, indicated in FIG. 9B, of the output flow 117 when it leaves the outflow region 115. The arrangement of the fabric meshes in the fabric laminate 81 and mesh widths of the fabric meshes can be configured and selected in such a way that an outflow of gas from the duct housing 109 through the fabric laminate 81 is effected in which, for example, there is a variation in the flow speed in the region of 10 percent or less at a very small distance, virtually directly at the outflow surface of the fabric laminate, from the fabric laminate 81. The arrangement of the fabric meshes in the fabric laminate 81 and the mesh widths of the fabric meshes can moreover be configured and selected in such a way that, in the case of an elevated pressure within the range from 1 mbar to 30 mbar in the plenum, there is an outflow speed which is less than 1 m/s.

The described homogenization with a fabric layer or a fabric laminate makes it possible to achieve a uniform outflow of gas even when the available build space is small and in the case of a feed line with a small cross-section. A uniform outflow can thus take place from a wall or cover into a space, for example a manufacturing space, in order to ensure, for example, an efficient flushing process for a clean atmosphere in the manufacturing space.

The outflow, for example, from the duct wall sections, designed as a metal fabric, in FIG. 1 takes place in a directed fashion—along the surface normal 119 in FIG. 9B—and with a homogeneous speed distribution over the whole surface without generating larger flow hot spots and smaller areas of macroscopic turbulence and recirculation. This is advantageous compared with conventional configurations with perforated plates as are used in the exemplary embodiment in FIG. 10.

The fact that the fabric meshes are distributed uniformly in rows and/or columns over the outflow surface and within a layer have a comparable/identical mesh width also contributes to the prevention of flow hot spots and inequalities. This can be advantageous for nonwovens (for example, ceramic nonwovens) in which the micro ducts which allow the passage of gas are not distributed regularly and evenly as in the case of a fabric and instead are distributed randomly over the upper surface such that flow hot spots and inequalities result which can have an effect on an output flow.

By virtue of their ability to be adjusted in varied ways, fabric laminates can be used for a wide range of flow speeds inside a flow duct or as an outflow surface (for example, a limit surface in the region of a wall of a housing) for equalization and homogenization of the speeds. It is moreover advantageous that the metal fabric can be processed in the manner of conventional metal sheets and is amenable to processing methods such as laser cutting, bending, and welding.

The surface flow discharge section 35 shown in FIG. 2 moreover has a flat feed duct 91 accommodated in the door 9A. A direction of flow in the Z direction is associated with the feed duct 91 in FIG. 2. The direction of flow runs within an angular range of 90° to the direction of flow of the primary stream P over preferably the whole width of the primary stream P (in the X direction). A gas-permeable fabric laminate 92 (for example, consisting of a plurality of metal fabric layers) which has a flow-homogenizing effect is provided in the upper region of the feed duct 91. Redirection vanes 36, which redirect the gas stream from the Z direction into the Y direction, can be used to promote the homogeneous and low-turbulence redirection. The 90° redirection can moreover also be utilized here “over the whole width” in order to utilize a recirculation-free inflow of the shielding gas for the formation of the most laminar and homogeneous primary stream P possible.

As is moreover shown in FIG. 2, the available intermediate space in the door panel of the door 9A can be used as a calming section for a pulsation-free and homogeneous inflow. An upstream distribution of the shielding gas stream is effected over the whole outflow width in the door panel. In other words, the shielding gas stream flows down in the door 9A essentially orthogonally to the process plane and is then redirected over the whole outflow width, as a result of which uniform inflow vectors can be generated within the process plane. The upstream distribution can be supplemented by the claimed redirection plates (vanes 36) and a perforated plate (with the, for example, round openings 35A), placed downstream from them, with a small flow-through surface. Such a configuration of baffles can enable largely turbulence-free redirection of the whole stream by, for example, 90° in FIG. 2 in the door 9A. The upstream fabric laminate 92 can additionally equalize the flow speed and outflow direction.

FIG. 10 shows an alternative design of a shielding gas module with perforated plates. Outflow ducts 3A′, 3B′ of the shielding gas module have a cross-section which corresponds to that of the outflow ducts 3A, 3B with regard to the duct wall 51. There is, however, a Y-shaped subdivision of the duct interior 53 into three regions, an entry region 93, an intermediate region 95, and a base region 97. The intermediate region 95 is delimited by intermediate walls 95A, 95B from the entry region 93 and from the base region 97, and the entry region 93 is separated from the base region 97 by an intermediate wall 95C (which is gas-tight in the example).

The shielding gas flows first into an entry region 93 through holes 92. The entry region 93 is fluidically connected to the manufacturing space 5 via holes 93A via a configuration of perforated plates on the inner side (in this case, in the inner side region 55 and partially on the upper bevel of the transition region 57).

The shielding gas can moreover flow from the entry region 93 through large-area opening arrangements 99 in the intermediate walls 95A, 95B, via the intermediate region 95 into the base region 97. The opening arrangements 99 effect a homogenization and even distribution of the shielding gas through the perforated plate geometries placed one after the other.

The base region 97 is fluidically connected to the manufacturing space 5 via holes 97A via a configuration of perforated plates on the underside (in this case, in the underside region 57 and partially on the upper bevel and the lower bevel of the transition region 57).

In addition or as an alternative to the perforated plates, fabric layers or fabric laminates can be provided.

FIG. 10 thus shows a further example of an arrangement of outflow ducts which each comprise a duct wall for delimiting a duct interior, wherein each of the outflow ducts comprises duct wall sections, which allow the passage of gas, in an inner side region, facing the respective other outflow duct, of the duct wall and in an underside region, facing the working surface, of the duct wall, and wherein the duct wall sections which allow the passage of gas are provided in a duct direction of the outflow duct over an outflow length which corresponds to at least the extent of the powder bed in the duct direction.

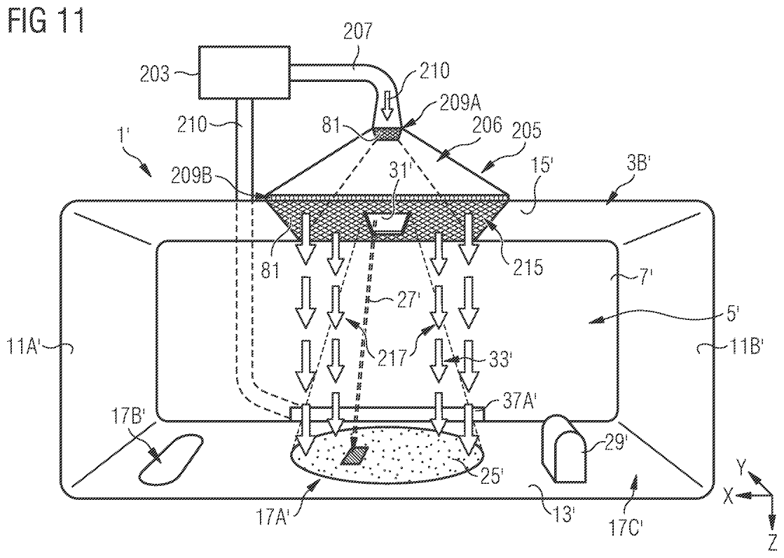

FIG. 11 shows a further embodiment of a manufacturing device 1′ for generating a large-area sinking stream with the use of a fabric laminate.

As in FIG. 1, the manufacturing device 1′ provides the manufacturing space 5′ for additive manufacture. Reference should be made to FIG. 1 for a further description. The manufacturing space 5′ is, for example, likewise delimited by a rear wall 7′, a front wall 9′ (not illustrated), and two side walls 11A′ and 11B′ in the X and Y directions. The manufacturing space 5′ is delimited at the bottom and the top (i.e. in the Z direction) by a working surface 13′ and a top wall 15′.

A powder bed region 17A′, a powder removal region 17B′, a powder supply region 17C′, powder 25′, a laser beam 27′, and a spreader 29′ can also be seen.

The top wall 15′ comprises a protective glass window 31′ which is arranged above the powder bed region 17A′ and through which the laser beam 27′ is coupled into the manufacturing space 5′. The laser beam 27′ there passes through a beam passage zone 33′ which extends between the protective glass window 31′ and the powder bed region 17A′.

A duct component 205 of a system for discharging a homogenized flow is integrated into the top wall 15′ as part of a shielding gas system. The duct component 205 forms a funnel-shaped widening region 206 as a plenum which opens out in an outlet opening 209B. An inlet opening 209A, through which a gas stream 210, fed by a low-pressure compressor 203 with a fluid line 207, can flow into the widening region 206 is moreover provided in the duct component 205. A fabric laminate 81 in the outlet opening 209B forms a flat outflow region 215 which discharges a homogenized output flow 217.

The manufacturing space 5′ represents a circulation chamber which is fluidically connected to the outlet opening 209B of the duct component 205. The manufacturing space 5′ (in FIG. 11, in particular an absorber opening 37A′) is moreover fluidically connected via a suction fluid connection 210 to the low-pressure compressor 203 (in particular the low-pressure side of the low-pressure compressor 203), as a result of which a closed shielding gas circuit is formed.

The outflow region 215 is formed by the fabric laminate 81, which allows the passage of gas, comprising a plurality of fabric layers, wherein each fabric layer of the fabric laminate 81 has fabric meshes which are provided as through openings for the flow-homogenizing passage of the gas in the Z direction. With regard to further details of embodiments of the fabric laminate 81, see in particular the description of FIG. 8.

The output flow 217 flows in the direction of a surface normal of the fabric laminate 81, in the Z direction in FIG. 11, such that the output flow 217 is formed between the flat outflow region 215 and the working surface 13 as a large-area, uniform shielding gas/sinking stream.

A further fabric laminate 81 can optionally be provided in the inlet opening 209A of the duct component 205. In alternative embodiments, the outflow region 215 can moreover be provided at the side walls 11A′, 11B′ or at the front wall/door/rear wall 7′ of a space to be flushed with gas.

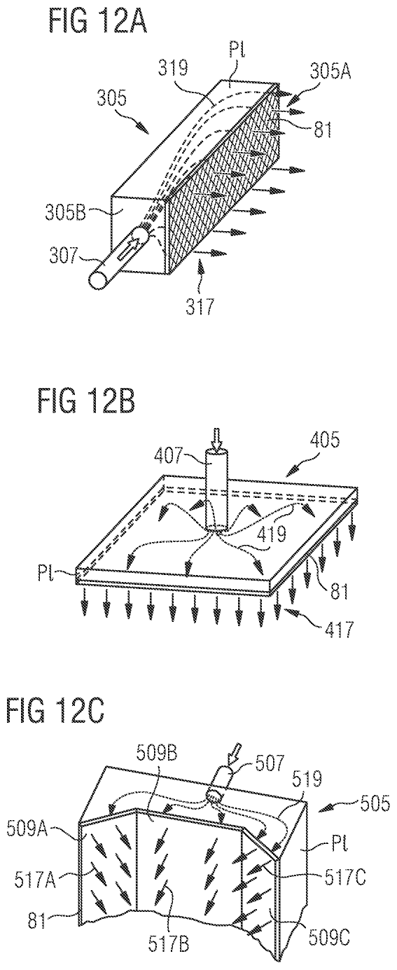

FIGS. 12A to 12C show duct components 305, 405, 505 with different geometries. In general, the duct housing can comprise a rear side wall situated opposite an outlet opening and side walls adjoining the rear wall. The outlet opening can form at least part of an outflow side wall which is connected to the rear wall in particular via the side walls. In general, at least part of an outflow side wall can be formed by a fabric laminate. Moreover, in general the inflow opening can be arranged in the rear side wall or one of the side walls. As shown in particular in connection with FIG. 12C, the fabric laminate can have a planar design and form at least one surface section of the duct housing. If optionally a plurality of surface sections are formed as a fabric laminate, they can be oriented relative to one another at an angle within the range from 0° to 90°, wherein neighboring surface sections can in particular adjoin one another.

For example, the duct component 305 in FIG. 12A demonstrates the formation of a square plenum P, the large side face 305A of which is formed by a fabric laminate 81. Gas is fed from the low-pressure compressor, for example, at a small side face 305B via a fluid line 307. Flow paths 319 in the plenum P are indicated by way of example. The output flow 317 emerging orthogonally to the large side face 305A is indicated schematically by arrows.

The duct component 405 in FIG. 12B has a plate-shaped design with a square basic shape such that there is a plenum P with a small height in comparison with the lateral extents. The plenum P is supplied with gas at a slight elevated pressure of a few millibars to some 10 mbar centrally from above via a fluid line 407. The gas emerges uniformly orthogonally to the base surface as an output flow 417 through a fabric laminate 81 which forms the base of the duct component 405. In some embodiments, an impact plate (not shown) can be provided in the region of the fluid line 407 in the plenum P in order, despite the low height, to generate comparable flow paths 419 (run lengths) in the plenum P between the inlet opening and the different regions of the outlet opening.

The duct component 505 in FIG. 12C demonstrates how a plurality of wall sections of a duct housing of the duct component 505 can be formed from a fabric laminate 81. By way of example, three sections 509A, 509B, 509C form a front wall of a plenum P, from which respective large-area homogeneous output flows 517A, 517B, 517C emerge. The three sections 509A, 509B, 509C are arranged, for example, at an angle to one another within the range from 10° to 30° such that the lateral output flows 517A, 517C counteract the divergence of the resulting overall flow. The gas feed by a fluid line 507 is indicated, for example, on the rear side of the duct component 505. Flow paths 519 in the plenum P are moreover indicated by way of example.

The fluid lines in FIGS. 12A to 12C are fluidically connected, for example, to low-pressure compressors such that in each example a gas at an elevated pressure of a few millibars to some 10 mbar can be applied to the plenum P.

In the examples shown, flat fabric laminates, in particular with a planar design, form a limit surface for a space in which it is intended to generate a homogenized output flow. For this purpose, gas is flowed in over an inflow side of the fabric laminate. The gas feed is such that there is a pressure difference of a few millibars up to some 10 mbar, a maximum of 200 mbar to 300 mbar, with respect to the inflow side of the fabric laminate and an outflow side.

Further aspects regarding the use of fabric laminates, in particular metal fabric laminates, are summarized below.

Aspect 1A. A system for homogenizing a flow, with:

a low-pressure compressor (100) which is configured to supply gas fed in at an input pressure to a compressor output (103A) at an output pressure which is greater than the input pressure by in the region of some 10 mbar, and

a duct component (86) comprising:

a duct housing with an inlet opening which is fluidically connected to the compressor output, and an outlet opening for forming a duct between the inlet opening and the outlet opening, and

a fabric laminate (81), arranged in the duct housing between the inlet opening and the outlet opening and extending transversely over the whole of the duct, with at least two fabric layers, wherein each of the fabric layers has a plurality of fabric meshes (82), each of the plurality of fabric meshes (82) forms a through opening, and the through openings of the plurality of fabric meshes (82) are formed so that they are uniformly distributed in the respective fabric layer such that in particular a flow through the fabric laminate (81) has a flow-homogenizing effect on a gas stream in the duct component (86).

Aspect 1B. A system (100) for discharging a homogenized output flow (117), with:

a low-pressure compressor (103) which is configured to supply gas fed in at an input pressure to a compressor output (103A) at an output pressure which is greater than the input pressure by in the region of some 10 mbar, and wherein the low-pressure compressor (103) is configured for a maximum increase in pressure of 300 mbar, and

a duct component (105) comprising:

a duct housing (109) with an inlet opening (109A) and an outlet opening (109B), and

a fabric laminate (81), covering the outlet opening (109B), which has a plurality of fabric layers (81A, 81B, 81C, 81D), wherein each of the fabric layers (81A, 81B, 81C, 81D) has a plurality of fabric meshes (82), each of the plurality of fabric meshes (82) forms a through opening, and the through openings of the plurality of fabric meshes (82) are formed so that they are uniformly distributed in one of the plurality of fabric layers (81A, 81B, 81C, 81D).

Aspect 2. A system (100) according to aspect 1B, wherein:

the duct housing (109) comprises a rear side wall (XX) situated opposite the outlet opening (109B), and side walls (XX) adjoining the rear wall (XX), and an outflow side wall (XX),

the fabric laminate (81) forms at least one section of the outflow side wall (XX), and

the inflow opening (109A) is arranged in the rear side wall (XX) or one of the side walls (XX).

Aspect 3. A system (100) according to aspect 1B or aspect 2, wherein the arrangement of the fabric meshes (82) in the fabric laminate (81) and the mesh widths (83) of the fabric meshes (82) are configured in such a way that
an outflow of gas from the duct housing (109) through the fabric laminate (81) is effected in which the variation in the speed of flow at the outflow surface of the fabric laminate (81) is in the region of 10% or less, and/or
in the case of an elevated pressure within the range from 0.5 mbar to 30 mbar, in particular within the range from 1 to 5 mbar, there is an outflow speed which is less than 1 m/s.

Aspect 4. A system (100) according to one of the aspects 1B to 3, moreover having:

a circulation chamber which is fluidically connected to the outlet opening (109B), and

a suction fluid connection (210) from the circulation chamber to the low-pressure compressor (103), as a result of which a closed flow circuit is formed.

Aspect 5. A system (100) according to one of the aspects 1A to 4, wherein the low-pressure compressor (103)
is designed to generate a continuous stream of gas and/or
is configured for a maximum increase in pressure within the range from 10 mbar to 300 mbar, and/or
is designed as a side duct compressor or axial ventilator.

Aspect 6. A system (100) according to one of the aspects 1A to 5, wherein the duct component (105) comprises a widening region (206) into which a stream of gas (113) can flow through the inlet opening (103A) in an inflow direction, and the inflow direction runs in the direction of a surface normal (119) of the fabric laminate (81), in particular in an outflow direction from the fabric laminate (81).

Aspect 7. A system (100) according to one of the aspects 1A to 5, wherein the duct component (105) comprises a widening region (206) into which a stream of gas (103) can flow through the inlet opening (101) in an inflow direction, and the inflow direction runs within an angular range from 60° to 120° in particular transversely to a surface normal (119) of the fabric laminate (81), in particular within an angular range from 60° to 120° to the outflow direction from the fabric laminate (81).

Aspect 8. A system (100) according to one of the preceding aspects, wherein

fabric meshes (82) of one of the plurality of fabric layers (81A, 81B, 81C, 81D) have a standard geometry, for example rectangular, square, diamond-shaped, round, or elliptical, and a standard mesh width (83) in at least one direction, and/or

mesh widths (83) of the fabric meshes (82) of the plurality of fabric layers (81A, 81B, 81C, 81D) are between 10 μm and 2 mm, and/or

mesh widths (83) of a group of successive fabric layers of the plurality of fabric layers (81A, 81B, 81C, 81D) decrease in a direction of throughflow of a stream of gas flowing through the fabric laminate (81′), and/or

a mesh width (83) of an output fabric layer (81D) is designed as a protective layer through which a stream of gas leaves the fabric laminate (81, 81′) and which has a mesh width (83) which is larger than a smallest mesh width of the plurality of fabric layers (81A, 81B, 81C, 81D).

Aspect 9. A system (100) according to one of the preceding aspects, wherein

the fabric meshes (82) formed so that they are uniformly distributed are arranged in rows and columns in the respective fabric layer (81A′, 81B′, 81C′, 81D′) and/or

the fabric laminate (81, 81′) has a planar design at least in one surface section (XX), wherein optionally a plurality of surface sections (XX) with a planar design are oriented relative to one another at an angle within the range from 0° to 90° and/or neighboring surface sections adjoin one another.

Aspect 10. A system (100) according to one of the preceding aspects, wherein the fabric laminate (81) comprises at least one metal fabric layer and is designed in particular as a metal fabric laminate, wherein in particular

the metal fabric layer is made from stainless steels, for example stainless steel 1.4401 or 1.4404, chromium-nickel-molybdenum steels, or a nickel-based alloy, for example Hastelloy alloy or Inconel alloy, and/or

at least two metal fabric layers are connected to each other by a sintering process.

Aspect 11. A manufacturing device (1′) for the additive manufacture of a three-dimensional component from a powder (25′) with:

a working surface (13′), side walls (11A′, 11B′), and a top wall (15′) which delimit a manufacturing space (5′), and

with a shielding gas system comprising
a system for homogenizing a flow according to aspect 1A with developments according to the aspects 7 to 10 and/or
a system (100) for discharging a homogenized output flow (217) according to aspect 1B with developments according to the aspects 2 to 10 which is configured to flow gas into the manufacturing space (5′) through a fabric laminate (81).

Aspect 12. A manufacturing device (1′) according to aspect 11, wherein the fabric laminate (81) is designed as part of the side walls (11A′, 11B′) and/or the top wall (15′), wherein the fabric laminate (81) forms a flat gas-permeable outflow region (215) which acts in particular as a flow homogenizer.

Aspect 13. A method for discharging a homogenized output flow (117), comprising:

supplying a fabric laminate (81) with a flat, in particular planar design which forms a limit surface for a space in which the homogenized output flow (117) is to be generated and which is designed, for example, according to one of the aspects 8 to 10, and

flowing in a gas over an inflow side of the fabric laminate (81), wherein there is a pressure difference of a few millibars up to some 10 mbar, a maximum of 200 mbar to 300 mbar, with respect to the inflow side of the fabric laminate and an outflow side.

The aspects described herein are based partly on the insight that the practicality of an additive manufacturing device can be improved by a large-area homogeneous sinking flow in combination with a large-area shielding flow flowing along the protective glass window because in this way not only can smoke be prevented from rising up in the manufacturing space and/or being deposited on the protective glass window, but also homogeneous flow conditions are created—a fundamental requirement for consistently high manufacturing quality.

Examples of gases which are applicable for the flow concepts disclosed herein comprise shielding gases such as noble gases as are usually used in LMF machines.

It is explicitly emphasized that all features disclosed in the description and/or the claims should be regarded as separate and independent of one another for the purpose of the original disclosure and likewise for the purpose of restricting the claimed invention independently of the combinations of features in the embodiments and/or the claims. It is explicitly stated that all range indications or indications of groups of units disclose any possible intermediate value or subgroup of units for the purpose of the original disclosure and likewise for the purpose of restricting the claimed invention, in particular also as a limit of a range indication.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

manufacturing device 1
outflow ducts 3A, 3B, 3A′, 3B′
manufacturing space 5
rear wall 7
front wall 9
door 9A
side walls 11A, 11B
working surface 13
top wall 15
powder bed region 17A
powder removal region 17B
powder supply region 17C
substrate plate 19
component 21
powder 25
laser beam 27
spreader 29
protective glass window 31
beam passage zone 33
surface stream discharge section 35
outlet openings 35A
suction section 37
intake opening 37A
redirection box 41
feed duct 43
fin 43A
perforated plates 43B
transition duct section 45
feed duct width 47
outflow duct width 49
duct wall 51
duct interior 53
inner side region 55
underside region 57
transition region 59
duct wall sections 55A, 55B, 57A, 57B, 59A, 59B which allow the passage of gas
beveled outer surfaces 61A, 61B
rounded outer surface 62
outflow length 63
regions 65
fabric laminate 67
baffles 69
openings 69A
sinking flow 71
turbulent flow 73
metal fabric laminate 81
metal fabric layers 81A, 81B, 81C, 81D
mesh width 83
flow 85
speed profile 87A, 87B
feed duct 91
entry region 93
intermediate region 95
intermediate wall 95A, 95B, 95C
base region 97
opening arrangements 99
openings
radius R
primary shielding gas stream P
secondary shielding gas stream S
secondary substream S_A, S_B
streams S_1, S_2, S_3
length L of the outflow ducts
extent A of the powder bed duct axis K
transition duct axis ZK

1. A manufacturing device for additive manufacture of a three-dimensional component from a powder, the manufacturing device comprising:
a working surface and a top wall delimiting a manufacturing space, wherein the working surface includes a powder bed region, the top wall includes a protective glass window disposed above the powder bed region and the manufacturing space includes a beam passage zone disposed between the protective glass window and the powder bed region wherein a laser beam can be emitted through the protective glass window and the beam passage zone to irradiate powder in the powder bed region, and
a shielding gas system having two outflow ducts, each disposed on the top wall and extending along a duct axis K on each side of the beam passage zone, each output duct having a duct wall defining a duct interior and having duct wall sections at an inner side region of each duct wall facing the respective other outflow duct, and at an underside region of the duct wall facing the working surface, wherein the duct wall sections allow passage of gas and extend along the duct over an outflow length corresponding at least to an extent of the powder bed region.

2. The manufacturing device as claimed in claim 1, wherein the shielding gas system further includes a shielding substream, associated with the inner side region of each outflow duct and flowing partially along the protective glass window and directed along the top wall, and a sinking substream associated with the underside region of each outflow duct and directed perpendicularly at the working surface.

3. The manufacturing device as claimed in claim 1, wherein, in at least one of the outflow ducts, the inner side region transitions into the underside region in a transition region, the transition region having one or more beveled outer surfaces, wherein at least one of the one or more beveled outer surfaces has a rectangular planar surface.

4. The manufacturing device as claimed in claim 1, wherein, in at least one of the outflow ducts, the inner side region transitions into the underside region in a transition region, the transition region having a rounded outer surface having a radius of curvature within a range from 10 mm to 200 mm.

5. The manufacturing device as claimed in claim 4, wherein, at least one shielding/sinking substream is associated with the transition region and is directed into the beam passage zone and enters the beam passage zone at an angle within a range from 10° to 80° relative to the top wall.

6. The manufacturing device as claimed in claim 1, wherein at least one of the duct wall sections is formed from fabric, and
wherein the fabric includes fabric meshes provided as outflow openings for the passage of gas from the duct interior into the manufacturing space.

7. The manufacturing device as claimed in claim 1, wherein at least one of the duct wall sections extends over at least 60% of a duct length of one of the outflow ducts and/or
comprises a nonwoven laminate or a perforated plate with an arrangement of outflow openings.

8. The manufacturing device as claimed in claim 1, wherein at least one of the outflow ducts comprises
at least one baffle extending from the inner side region toward a center of the duct interior and wherein gas flowing along the outflow duct is deflectable toward a duct wall section of the inner side region wherein the at least one baffle
is curved and/or
is provided with openings close to a center of the duct interior, and/or
is formed from at least one fabric layer, fabric laminate, metal fabric laminate, or nonwoven laminate, arranged transversely to the duct axis.

9. The manufacturing device as claimed in claim 1, wherein the shielding gas system further comprises a redirection box with a feed duct and two transition duct sections fluidically connected to the feed duct, wherein
each of the transition duct sections is fluidically connected to one of the outflow ducts at the outlet side, and
at least one of the transition duct sections is configured to fan out a stream of gas and is adapted to a cross-section of the fluidically connected outflow duct.

10. The manufacturing device as claimed in claim 9, wherein
at least one of the transition duct sections is fluidically connected to one of the outflow ducts at an angle between a transition duct axis and the duct axis within a range from 80° to 100°, and/or
the transition duct sections and the outflow ducts are formed in the connecting region in each case with a flattened cross-section with a width-to-depth ratio of at least 2:1.

11. The manufacturing device as claimed in claim 9, wherein
at least one of the transition duct sections is integrated into a rear wall of the manufacturing device which extends between the working surface and the top wall and delimits the manufacturing space.

12. The manufacturing device as claimed in claim 1, wherein the shielding gas system further comprises a surface stream duct system for supplying a surface stream which flows over the working surface.

13. The manufacturing device as claimed in claim 12, wherein the surface stream duct system has a surface stream discharge section and a suction section, and
the surface stream discharge section is configured
to guide gas to at least one outlet opening which extends in a strip along the working surface, and
to effect a uniform flow of the gas into the manufacturing space, and
the suction section is configured
to draw gas from the manufacturing space through an intake opening, wherein the intake opening extends in a strip along the working surface, and
to effect a uniform intake of gas from the manufacturing space.

14. The manufacturing device as claimed in claim 13, wherein the surface stream discharge section has a flat feed duct a direction of flow associated with the flat feed duct runs at an angle within the range from 80° to 100° to the direction of flow of the surface stream emerging from the outlet opening.

15. The manufacturing device as claimed in claim 13, wherein the shielding gas system forms a flow pattern which comprises
as a primary flow component:
the surface stream which flows at a small distance above the working surface, and
as a secondary flow component:
the shielding substreams which flow from the two outflow ducts along the top wall, meet each other, and then flow onward together in the direction of the working surface,
the sinking substreams which flow from the underside regions to the working surface, and
optionally further shielding/sinking substreams which flow from the transition regions obliquely into the beam passage zone and then flow onward in the direction of the working surface,
as a result of which a sinking flow is formed in the beam passage zone toward the working surface which is drawn, together with the surface stream, through the intake opening out of the manufacturing space.
